(19) United States
(12) Patent Application Publication
(10) Pub. No.: US 2010/0061547 A1
(43) Pub. Date: Mar. 11, 2010

(54) METHOD OF AND APPARATUS FOR THE REDUCTION OF A POLYNOMIAL IN A BINARY FINITE FIELD, IN PARTICULAR IN THE CONTEXT OF A CRYPTOGRAPHIC APPLICATION

(76) Inventors: Peter Langendörfer, Frankfurt (Oder) (DE); Steffen Peter, Frankfurt (Oder) (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/225,357

(22) PCT Filed: Mar. 21, 2007
(86) PCT No.: PCT/EP2007/052707

§ 371 Date: Jun. 22, 2009

(30) Foreign Application Priority Data
Mar. 22, 2006 (DE) 10 2006 013 989.5

(51) Int. Cl. H04L 9/28; G06F 7/483; G06F 7/72

(52) U.S. Cl. 380/28; 708/446

(57) ABSTRACT

A method of reducing a first data word corresponding to a polynomial C(x) and having a length of a maximum of 2n−1 to a second data word of a length of a maximum m which in a binary finite field GF(2^{m}) whose elements are of a maximum length m corresponds to a polynomial C″0(x) equivalent to C(x), wherein m is smaller than or equal to n, includes partitioning of the first data word into a binary first sub-data word C0 and a binary second sub-data word C1, repeated right-shift of C1 to form summand terms until a respective summand term is associated with each non-disappearing term of a reduction trinomial or pentanomial which is not the term x^{m}, adding the summand terms formed to the first sub-data word to form a sum data word and applying the partitioning step to the summand data word formed until the ascertained sum data word is of a length of a maximum m and forms the desired second data word.

The invention concerns a method of and an apparatus for the reduction of a binary first data word corresponding to a polynomial C(x) and having a length of a maximum of 2n−1 to a second data word of a length of a maximum m which in a binary finite field whose elements are of a maximum length m corresponds to a polynomial C″0(x) equivalent to C(x), wherein m is either smaller than or equal to n. The invention further concerns a cryptography method and a cryptography apparatus.

Cryptographic methods serve for protecting data from unauthorized access. Cryptographic methods transform the data to be protected into encrypted data, in particular with the incorporation of private keys. Cryptographic methods also serve for the decryption of the encrypted data using the private key for restoring the data to be protected.

Asymmetrical encryption methods such as RSA and elliptic curve cryptography (ECC) are used to ensure a secure exchange of keys for cryptographic methods and to calculate digital signatures.

Elliptic curve cryptography requires a markedly shorter key length than RSA with the same security level. In addition, for elliptic curve cryptography, it is possible to use binary finite Galois fields GF(2^{m}) which are highly suited to hardware implementations by virtue of their algebraic properties. In that respect m specifies the length of the elements of a respective Galois field.

The most important operation in application of elliptic curve cryptography is the multiplication of large polynomials. After a polynomial multiplication in a finite field the possible resulting products are known to be longer than the largest element of the underlying finite field. Therefore what is referred to as a reduction procedure has to be carried out after a polynomial multiplication. In that reduction the long polynomial of the resulting product is transformed to an (“equivalent”) value in the limits of the field. That operation is necessary after each polynomial multiplication.

As multiplication in elliptic curve cryptography represents a main operation, accordingly it is not just the multiplication operation alone that is critical for the performance in the sense of rapidity of an ECC implementation, but also the reduction operation.

Reduction corresponds to division with remainder (modulo operation) in “normal” finite fields. That will be explained by reference to a simple example. The finite field GF(7) consists of the elements {0, 1, 2, 3, 4, 5, 6}. Multiplication of 5*4 gives 20, which is greater than the greatest possible element in the field. In that case 20 is divided by 7 and the remainder of that division, namely 6, is then also the result of the multiplication of 5*4 within the finite field (GF(7)).

Binary finite fields (GF(2^{m})) do not contain any numbers but polynomials. An element of those fields is A(x)=aₘ₋₁*x^{m-1}+aₘ₋₂*x^{m}⁻²+ . . . +a₁*x+a₀. The coefficients aₗ are in that case either 0 or 1. An important property of the fields is that the XOR operation is used in the addition and subtraction of coefficients. Accordingly 1+1≡1−1≡1 XOR 1=0.

The maximum length of an element of the field GF(2m) is m. The multiplication of two elements (A(x)*B(x)) gives twice as long a polynomial C(x)=A(x)*B(x)=cₘ₋₂*x^{2m-2}+ . . . +c₀. The result is therefore of a length of 2m−1.

It is now possible to break down C(x) into C(x)=C1(x)*x^{m}+C0(x). In that case C0(x) is of a length corresponding to the maximum length of the polynomials of the field. C1(x) is the part which exceeds the maximum field length and which has to be integrated by means of the reduction process into C0.

That reduction can be solved by means of a complete polynomial division, which takes a very long time. Such a method precisely corresponds to the modulo division described hereinbefore by way of the example of GF(7).

Alternative faster options of implementing that reduction operation are known. An approach which is often used is multiplicative reduction. If C1(x) is multiplied by a reduction polynomial R(x) and the resulting product is subtracted from C(x) the result is smaller than the initial polynomial but equivalent in the underlying field. The following applies: C(x)≡C(x)−C1(x)*R(x). If that operation is repeated the result is further and further smaller values which however are equivalent in the underlying field. When C1(x) has reached the length of zero the reduction operation is concluded.

If the length of the field and the reduction polynomial R(x) are known it is possible to implement direct wiring of the reduction logic in a highly efficient manner. That is known for example from the publication Saqib, N. A., Rodriquez-Henriquez, F., and Diaz-Perez, A., “A parallel architecture for fast computation of elliptic curve scalar multiplication over GF(2^{m})”, 18th International Parallel & Distributed Processing Symposium (IPDPS), Santa Fe, N. Mex., 26-30 Apr. 2004.

The disadvantage of the system known from that publication however is that it precisely presupposes knowledge of the length of the field and of the reduction polynomial R(x). The endeavor therefore is to find a similarly efficient way which makes those operations possible for fields which are variable in relation to the running time with variable reduction polynomials in hardware terms.

An option which is already known from the document Eberle, H., Gura, N., and Chang-Santz, S., “A cryptographic processor for arbitrary elliptic curves over GF(2^{m})”, IEEE 14th International Conference on Application-specific Systems, Architectures and Processors (ASAP), Jun. 24-26, 2003, pages 444-454 involves using a complete multiplier for the reduction step C(x)−C1(x)*R(x). Additional complete multiplication at that location however is highly negative in terms of the speed of ECC implementation.

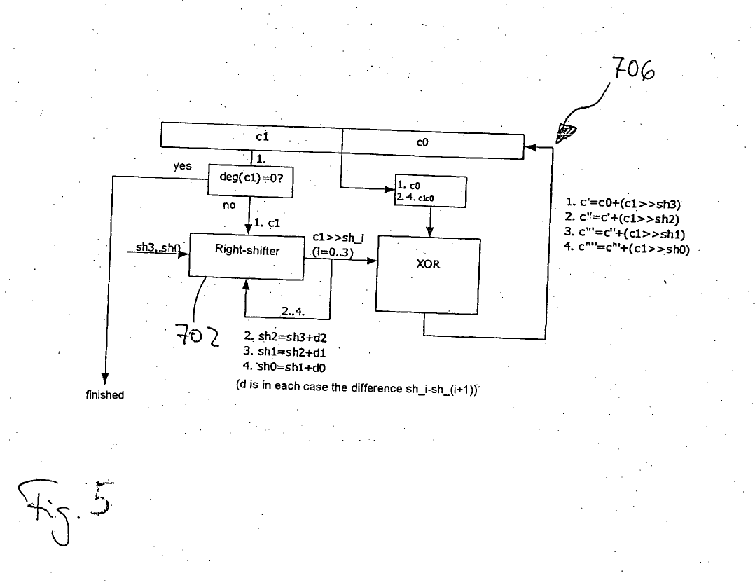

It is known from US No 2003/0208515 A1 (see therein FIG. 32), in the multiplicative reduction of centeredly oriented polynomials, to carry out a calculation step C′(x)=C1(x)*(M−x^{m})+x^{n-m}+C0(x) until the excessive part of the resulting polynomial disappears. In that case M identifies a suitable irreducible polynomial. The method includes storing the reduction polynomial without the term x^{m} shifted towards the left by n-m positions and filling the edge positions to left and right with the value zero. For a 233-bit implementation (m=233) with M=x²³³+x⁷⁴+1 on a 256-bit hardware (n=256), (M−x^{m})*x^{n-m}=(x⁷⁴+1)*x²⁵⁶⁻²³³=x⁹⁷+x²³. That polynomial which can be re-used for the entire reduction process is multiplied by the excess part C1(x) and added to C0(x) (XOR) until C1(x) is zero. Repeated complete polynomial multiplication operations are therefore necessary. Finally the equivalent reduced polynomial calculated in that way is shifted towards the left by multiplication by x^{m}.

A variant described in US No 2003/0208515 A1 (see FIG. 33) provides that, instead of the original polynomial, a partially reduced polynomial is used for the calculation of point multiplication operations in order only thereafter finally to effect reduction in accordance with the method just described above. In that way operations in fields GF(2^{m}) with different values m can be effected with one implementation.

A disadvantage with the methods described in that document however is that repeated complete polynomial multiplication operations have to be carried out for the reduction process. A large number of clock cycles is required for the reduction.

Therefore the technical object of the present invention is to provide a method of and an apparatus for the reduction of a polynomial product which permits a reduction which can be carried out in particularly few clock cycles in fields of differing length and with different reduction polynomials.

The invention is reflected in three aspects of which two aspects concern methods and a third aspect an apparatus.

In accordance with a first aspect of the invention there is provided a method of reducing a first data word corresponding to a polynomial C(x) and of a length of a maximum of 2n−1 to a second data word of a length of a maximum m. The second data word corresponds in a binary finite field GF(2^{m}) whose elements are of a maximum length m to a polynomial C″0(x) equivalent to C(x), wherein m is either smaller than or equal to n. The method comprises the following steps:
providing a reduction polynomial R(x) which forms a trinomial or a pentanomial;
partitioning the first data word into a binary first sub-data word C0 and a binary second sub-data word C1 whose corresponding polynomials C0(x) and C1(x) satisfy the equation C(x)=C1(x)*x^{m}+C0(x), and picking off the second sub-data word to form a first summand term;
right-shifting the second sub-data word to form a second summand term and repeating the right-shifting step to form further summand terms until a respective summand term is associated with each non-vanishing term of the reduction polynomial which is not the term x^{m} by the step width of a respective right-shift being equal to the difference of m and the order of a respective non-vanishing term of the reduction polynomial;
adding the formed summand terms to the first sub-data word to form a sum data word;
if the sum data word ascertained in that way is of a length greater than m, application of the method steps from the partitioning step to the summand data word formed until the sum data word ascertained in that way is of a length of a maximum m and thus forms the second data word.

The method according to the invention of reducing a first data word permits particularly fast execution in a few clock cycles in a hardware implementation. In a preferred embodiment described hereinafter reduction is even effected in just one clock cycle.

The method according to the invention involves various measures which lead to that acceleration in the reduction operation, in comparison with known methods.

In accordance with the invention there is firstly provided a reduction polynomial R(x) forming a trinomial or a pentanomial. Trinomials are polynomials with three occupied terms. Pentanomials are polynomials with five occupied terms. With that measure the method according to the invention makes use of the property of those binary finite fields which are used in practice in elliptic curve cryptography because they are recommended by the standardization committees such as for example the American National Institute of Standards and Technology (NIST).

As in addition the second highest occupied position of the recommended reduction polynomials is as a rule less than m/2 complete reduction can be concluded after two successive multiplication operations.

In addition, multiplication steps are effected in the method according to the invention by flexible shift operations. That leads to a substantial simplification in the multiplication steps required and at the same time flexible hardware implementation which makes it possible to reduce products of data words of differing length (which however is the same in a respective product).

Mathematically the reduction method according to the invention can be described as follows. With the starting point being a polynomial of the form

C(x)=C1(x)*x^{m}+C0(x) (1)

in a first iteration of the reduction operation the following difference is calculated:

C′(x)=C(x)−C1(x)*R(x) (2)

How that difference is calculated in a particularly simple fashion in accordance with the invention is described hereinafter. Equation (2) can also be represented as

C′(x)=C1(x)*x^{m}+C0(x)−(C1(x)*x^{m}+C1(x)*x^{m}/x^{s3}+C1(x)*x^{m}/x^{s2}+C1(x)*x^{m}/x^{s1}+C1(x)*x^{m}/x^{s0}) (3)

Equation (3) is equivalent to

C′(x)=C0(x)−(C1(x)*x^{m}/x^{s3}+C1(x)*x^{m}/x^{s2}+C1(x)*x^{m}/x^{s1}+C1(x)*x^{m}/x^{s0}) (4)

In that respect divisions by the terms x^{s3}, x^{s2}, x^{s1}, x^{s0} correspond to right-shift operations by a step width corresponding to the order of the non-vanishing terms x^{s3}, x^{s2}, x^{s1} and x^{s0} of the reduction polynomial.

In numerous cases, complete reduction can still not be achieved after that single application of the reduction polynomial. Therefore the procedure involves a next iteration step based on a representation of the intermediate result C′(x) in the form:

C′(x)=C1′(x)*x^{m}+C0′(x) (5)

The maximum length of the intermediate result C1′(x) is m−s3−1. The renewed application of the reduction polynomial is effected in accordance with the equation

C″(x)=C′(x)−C1′(x)*R(x)=C1″(x)*x^{m}+C0″(x) (6)

In that respect, if m<2*s3 the order of the term C1″(x) is zero. In that case therefore reduction requires only two iterations.

The step of partitioning the first data word, which is included in the method according to the invention, does not necessarily involve physically splitting up the first data word into two separate sub-data words or indeed the separate storage thereof in memories or registers. The only essential aspect in regard to the partitioning operation is that the sub-data words are used separately in the further course of the method. In an advantageous hardware implementation however separate wiring of the bit positions of the sub-data words in a register which includes the complete first data word, with respective subsequent operator implementations, can suffice for that purpose.

The reference to the length of a summand data word formed is used to denote the highest-value position, the value of which is different from zero. If therefore a summand data word is of a length of greater than m, that means that there are values different from zero at positions >m.

The step of right-shifting the second sub-data word to form a second summand term, which is included in the method according to the invention, and repetition of the right-shifting step to form further summand terms, are to be interpreted as meaning that as a result the second summand term is used shifted towards the right with respect to the second sub-data word (C1) in its original position in the first data word (C0+C1). That can be achieved not only by an actual right shift but for example also by a procedure whereby the second sub-data word is firstly picked off in right-flush relationship and then shifted towards the left by a step width which is to be respectively appropriately adapted. Clearly however the result is the same.

In accordance with a second aspect of the present invention there is provided a method of reducing a first data word corresponding to a polynomial C(x) and having a length of a maximum of 2n−1 to a second data word of a length of a maximum m which in a binary finite field GF(2^{m}) whose elements are of a maximum length m corresponds to a polynomial C″0(x) equivalent to C(x), wherein m is either smaller than or equal to n, comprising the steps:
providing a reduction polynomial R(x) which forms a trinomial or a pentanomial;
partitioning the first data word into a binary first sub-data word C0 and a binary second sub-data word C1 whose corresponding polynomials C0(x) and C1(x) satisfy the equation C(x)=C1(x)*x^{m}+C0(x), and picking off the second sub-data word to form a first summand term;
right-shifting the second sub-data word to form a second summand term and repeating the right-shifting step to form further summand terms until a respective summand term is associated with each non-vanishing term of the reduction polynomial which is not the term x^{m} by the step width of a respective right-shift being equal to the difference of m and the order of a respective non-vanishing term of the reduction polynomial;
adding the formed summand terms with the exception of the first summand term, to the first data word (hereinafter also referred to as the first adding step);
if the sum data word ascertained in that way is of a length greater than m, application of the method steps from the partitioning step to the summand data word formed until the sum data word ascertained in that way is of a length of a maximum m; and
adding the first summand term and in the stated case of an application of the method steps from the partitioning step to the formed summand data word each further second sub-data word which has been ascertained in the meantime to the last-ascertained sum data word to form the second data word (hereinafter also referred to as the second adding step).

The method of the second aspect of the invention differs from that of the first aspect of the invention in that the respective first summand terms, that is to say the respective second sub-data words, are only added finally, after execution of all required iteration operations for reduction of the last-ascertained sum data word in order to form the completely reduced second data word.

The additional advantage of the method of the second aspect of the invention is that even more compact hardware implementations are possible in that way. For, in a reduction apparatus according to the invention, a shift unit provided therein for carrying to that method only has to still carry out at a maximum three right-shift operations. That saves on chip area.

The method execution of this aspect of the invention is based on the insight that all irreducible polynomials are of the following structure:

R(x)=x^{m}+ . . . +1 (7)

The terms x^{m} and 1 are therefore part of a reduction polynomial R(x). As the lowest order of the reduction polynomial is always zero (x⁰=1) and s0 corresponds to the difference of m and zero, s0 is always equivalent to m. Therefore, no right shift is actually required for that term and the required addition can be effected following the iteration operations.

Further advantages of this method will be apparent from the description hereinafter of embodiments by way of example which however equally relate to the method in accordance with the first aspect of the invention. The embodiments by way of example can be combined with each other unless it is expressly described that these involve mutually alternative embodiments.

In accordance with a preferred embodiment of the methods according to the invention in which the first data word is of a length of less than 2n−1 an additional first adjustment step is effected prior to the right-shift operation. The first adjustment step includes a left-shift in respect of the first data word by a filling step width and an attachment at both sides of a number of zeros corresponding to the filling step width to the first data word. The left-shift and the attachment of the zeros are effected in such a way that the length of the first data word modified in that fashion is 2n−1 and that, in the modified first data word, those terms of the polynomial C(x) corresponding to the first data word, that are of an order of greater than m, are arranged at the same bit positions as if the first data word had already initially been of the length 2n−1.

It is possible in that way for even relatively small data words to be reduced in one and the same hardware implementation. That enhances the flexibility of a hardware implementation.

Preferably, in that execution of the method, a second adjustment step is carried out which in the method in accordance with the first aspect of the invention is carried out in particular after the addition of the summand terms formed to the first sub-data word to form the summand data word in the last iteration step. In the method in accordance with the second aspect of the invention the second adjustment step is carried out in particular prior to the second adding step.

In a particularly preferred embodiment of the methods according to the invention the irreducible polynomial is represented solely by the powers of the non-vanishing terms of the reduction polynomial, that are not the term x^{m}. That means that the reduction polynomial is not stored in the full length of a data word, but only in the form (s1, s2, s3). The execution of the method is thereby further simplified and speeded up. The additional parameter of the known maximum length m of data words of the binary finite field which is required for unique knowledge of the irreducible polynomial can but does not have to be stored together with the parameters (s1, s2, s3) as it is also present elsewhere.

A third aspect of the present invention concerns an asymmetric cryptography method for use in an electronic cryptography apparatus. The method includes reducing a first data word corresponding to a polynomial C(x) and of a length of a maximum of 2n−1 to a second data word of a length of a maximum m which in a binary finite field GF(2^{m}) whose elements are of a maximum length m corresponds to a polynomial C″0(x) equivalent to C(x), wherein m is either less than or equal to n, in accordance with a method according to the first or second aspect of the invention, or according to one of the embodiments, described in the context of this application, of the methods in accordance with the first or second aspect of the invention.

The term cryptography method is used here to denote a method of encrypting or decrypting a message represented in particular in the form of a data word. The term message is also used for example to denote a portion of a stream of data which assumes the form of a data word.

An embodiment of the cryptography method of the third aspect of the invention forms an elliptic curve cryptography method comprising, prior to the reduction operation, the multiplication of two factor data words corresponding to factor polynomials A(x) and B(x) to give the first data word corresponding to a polynomial C(x) and of a length of a maximum of 2n−1.

A further fourth aspect of the invention concerns a method of calculating a digital signature. The method includes an elliptic cryptography method with a reduction method in accordance with the first or second aspect of the invention or in accordance with one of the embodiments, described in the context of this application, of the methods in accordance with the first or second aspect of the invention.

A fifth aspect of the invention concerns an apparatus for the reduction of a first data word corresponding to a polynomial C(x) and of a length of a maximum of 2n−1 to a second data word of a length of a maximum m which in a binary finite field GF(2^{m}) whose elements are of a maximum length m corresponds to a polynomial C″0(x) equivalent to C(x), wherein m is either less than or equal to n, comprising:
a memory which contains a representation of at least one reduction polynomial R(x) which forms a trinomial or pentanomial;
a selection unit which is adapted to pick off a binary sub-data word from the first data word, whose corresponding polynomial C1(x) complies with the equation C(x)=C1(x)*x^{m}+C0(x) and which forms a first summand term;
a shift unit connected to the selection unit and adapted to shift the sub-data word towards the right by a respectively predetermined step width for forming a second or further summand term and to output the formed summand terms;
an adding unit connected to the shift unit and adapted to add a respective summand term and the summands outputted by the shift unit to the first data word; and
a control unit which is adapted
to determine the step width of a respective right-shift to be performed by the shift unit for forming a summand term as a difference of m and the order of a respective non-vanishing term of the reduction polynomial,
to instruct the shift unit for repeated execution of the right-shift step for a formation of further summand terms with respective freshly determined step width until a respective summand term is associated with each non-vanishing term of a respectively predetermined reduction polynomial which is not the term x^{m}, and
to again activate if necessary the calculation unit, the shift unit and the adding unit until an ascertained sum data word is of a length of a maximum m and thus forms the second data word.

The reduction apparatus according to the invention which is synonymously also referred to as the reducing apparatus permits rapid reduction of data words. It affords the prerequisite for a high degree of flexibility which in preferred embodiments permits the reduction of data words of differing length.

In comparison with known apparatuses that is effected with a particularly simple structure which manages without any dedicated multiplication unit. Suitable control of the flexible shift unit which shifts a selected sub-data word towards the right by a respectively predetermined step width, in conjunction with an adding unit, means that it is possible to execute multiplicative reduction by just a few simple shift and adding operations. The fact that the control unit is adapted to freshly activate if required the calculation unit, the shift unit and the adding unit until an ascertained sum data word is of a length of a maximum m and thus forms the second data word is not necessarily linked to a check step in which the length of a partially reduced data word is ascertained. Rather, no check in respect of the length takes place in a preferred implementation. In that respect use is made of the fact that a suitably selected reduction polynomial ensures that the reduction is complete after 2 iterations.

Embodiments by way of example of the apparatus according to the invention are described hereinafter. The embodiments can be combined together insofar as they are not expressly described as alternative embodiments.

In a preferred embodiment of the reducing apparatus the control unit is adapted to instruct the adding unit in the case of a repetition of the method steps from the step of ascertaining a binary sub-data word to add the respectively formed summand terms with the exception of the first summand term to the respective first data word and, after a finding that an ascertained sum data word is of a length which is no greater than m, for forming the second data word, to add each first summand term ascertained in the meantime to the ascertained sum data word.

That embodiment carries out the method of the second aspect of the invention.

A further preferred embodiment includes a first and a second adjustment unit. The first adjustment unit is adapted to shift an incoming first data word of a length of less than 2n−1 towards the left by a filling step width prior to the right-shift operation and to attach at both sides of the first data word a number of zeros corresponding to the filling step width to the first data word in such a way that the length of first data word modified in that fashion is 2n−1 and that in the modified first data word those terms of the polynomial C(x) corresponding to the first data word, which are of an order of greater than m, are arranged at the same bit positions as if the first data word had already initially been of the length 2n−1.

The second adjustment unit is adapted to shift the ascertained sum data word of the length of a maximum m towards the right by the filling step width and to remove the initially attached zeros.

To expedite the reduction operation the shift unit preferably includes a number of parallel-connected right-shifters to which the sub-data word is fed.

Alternatively the shift unit includes precisely one right-shifter and the control unit is adapted to carry out the repetition of the right-shift step for forming further summand terms by additional right-shifting of the summand term last outputted by the right-shifter by a respective difference step width, wherein the respective difference step width is the difference between the right-shifts of successive summand terms in each case with respect to the first summand term.

A sixth aspect of the invention forms a cryptography apparatus, in particular an electronic cryptography apparatus, which includes a reduction apparatus in accordance with the fifth aspect of the invention or an embodiment, disclosed in the context of this application, of that reduction apparatus.

In an embodiment the cryptography apparatus is adapted for encryption or decryption of data in accordance with an elliptic curve cryptography method. It will be appreciated that this includes the cryptography apparatus being adapted either only for encryption or only for decryption or both for encryption and also for decryption of data.

In a further embodiment the electronic cryptography apparatus includes a multiplication unit which is adapted to multiply two factor data words corresponding to factor polynomials A(x) and B(x) to form a first data word corresponding to the polynomial C(x) and of a length of a maximum of 2n−1. The multiplication unit can be integrated in one and the same chip with the reduction apparatus. It can however also be provided on a separate chip.

The invention and various embodiments by way of example are described in greater detail hereinafter with reference to the accompanying Figures in which:

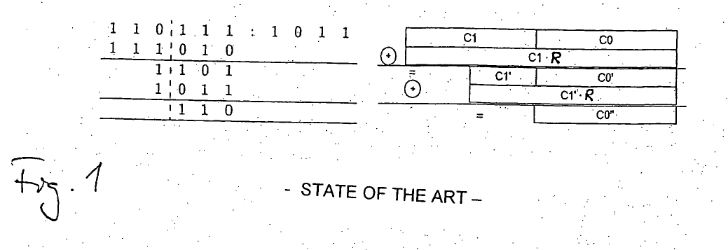

FIG. 1 shows a diagram to illustrate a simple polynomial reduction,

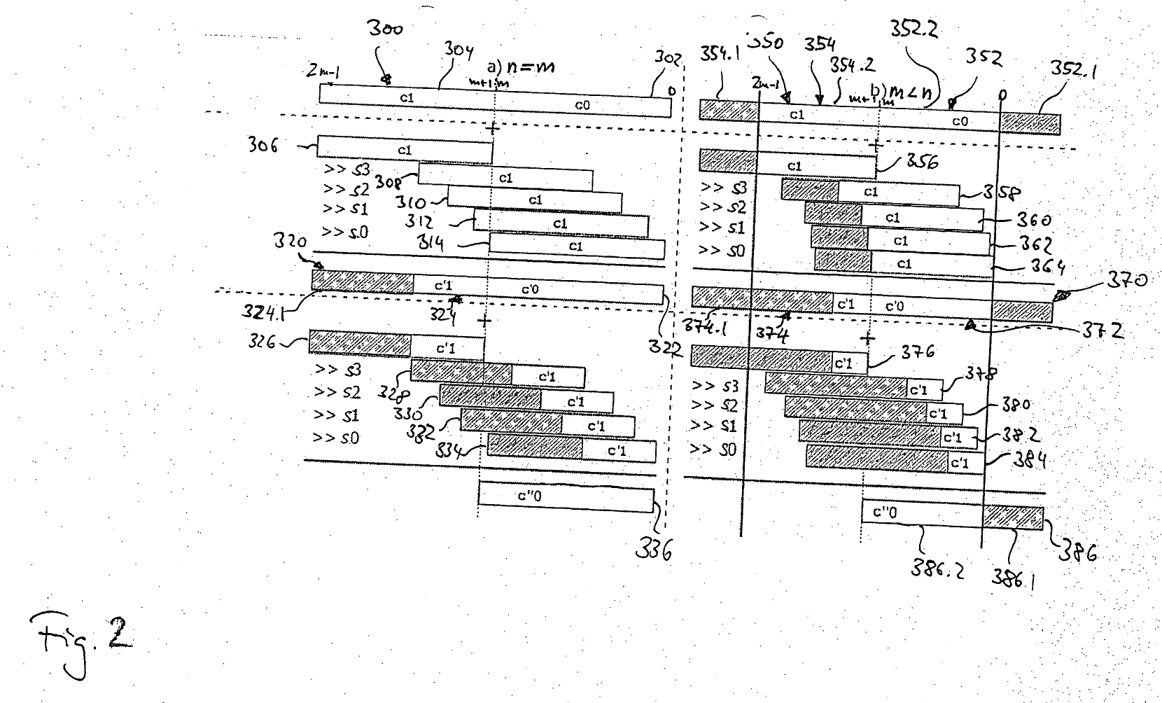

FIGS. 2a) and 2b) show two alternative configurations of the method according to the invention,

FIG. 3 shows a further alternative embodiment by way of example of the method according to the invention,

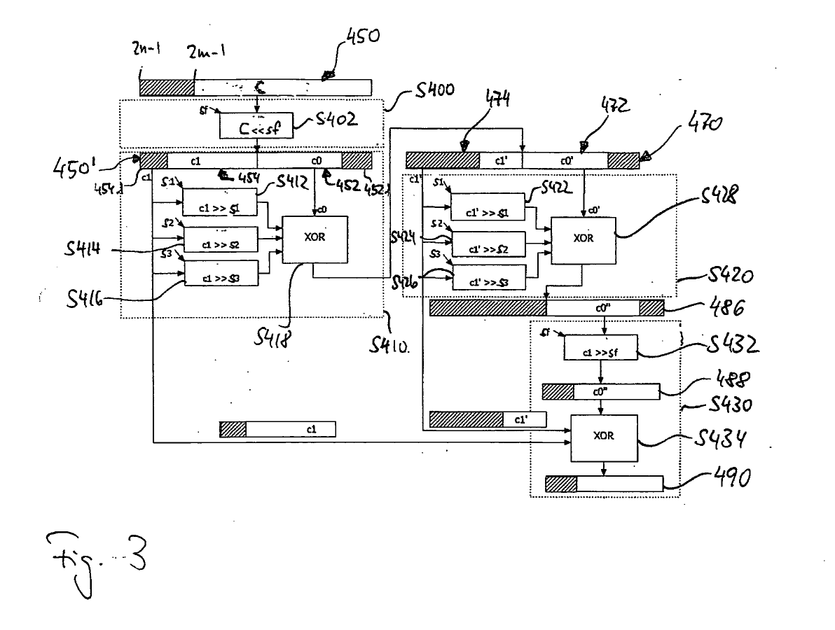

FIG. 4 shows a block diagram of an embodiment by way of example of a flexible reducer, and

FIG. 5 shows a block diagram to illustrate an alternative structure of a reducing unit for the flexible reducer of FIG. 4.

FIG. 1 shows a diagram to illustrate a simple polynomial reduction. The basic problem of polynomial reduction in finite binary fields is based on the fact that a polynomial multiplication operation produces a first data word which is of a greater length than the maximum length m of the field. Instead of field length, reference is also made to field degree. To fit the polynomial product into the binary finite field it has to be reduced. The reduction process corresponds to determining a data word, equivalent to the initial data word, in the binary finite field GF(2^{m}). The operation corresponds to the known modulo operation in prime fields.

An obvious reduction approach accordingly involves dividing the initial first data word by the irreducible polynomial. The remainder of that division is the reduced data word which is here also referred to as the second data word.

A second alternative reduction method is multiplicative reduction. In that method the overhanging part of the data word which is here also referred to as the second sub-data word is multiplied by the reduction polynomial and subtracted from the initial first data word. Subtraction corresponds as is known like addition to an XOR logical operation.

In the example shown in FIG. 1 the maximum field length of the binary finite field used m=3. After a first iteration step the result is a summand data word C′(x) which in turn can be represented as C1′(x)*x^{m}+C0′(x). The second sub-data word C1′ forming the overhanging part could therefore be reduced in size in comparison with the initial first data word. A further reduction which is effected by multiplication of the second sub-data word C1′(x) by the reduction polynomial R is however still required. As can be seen from the left-hand part of the diagram in FIG. 1, after those two reduction steps the initial first data word 110111 has been reduced by double multiplication of the respectively overhanging second sub-data word by the irreducible polynomial 1011 to the equivalent data word 110 in the field GF(2³).

It is emphasized that the example in FIG. 1 serves only to illustrate the principle involved. The numerical example used has been adopted for explanatory purposes and is uncharacteristic for the situation of use insofar as the length of the first data word is here 6. That corresponds to 2*m while after a multiplication operation the length of the data word to be reduced is no longer than 2*m−1.

FIGS. 2a) and 2b) show two alternative embodiments of the method according to the invention. The solution shown in FIGS. 2a) and 2b) is based on the properties of the finite binary fields which are recommended for example by the NIST for elliptic curve cryptography. As all additionally recommended reduction polynomials are either trinomials or pentanomials it is possible to replace a multiplication operation by 3 or 5 summed-up shift operations. As in addition the second highest occupied position in the reduction polynomials is generally smaller than m/2, complete reduction is concluded after two successive multiplication operations. The corresponding reduction process is illustrated by reference to two cases in FIGS. 2a) and 2b).

FIG. 2a) shows the method according to the invention for the situation where the length of the field permissible in hardware precisely corresponds to the length of the field (m=n), on which a preceding polynomial multiplication operation was carried out. A first non-reduced data word 300 of the length 2n−1 can be partitioned into two sub-data words 302 and 304 A first sub-data word C0 extends from the lowest bit position to the length m of the binary finite field GF(2^{m}). A second sub-data word C1 304 corresponds to the overhanging part of the first data word 300 and is of the length 2n−m−1.

The above-mentioned partitioning of the first data word 300 into the two sub-data words 302 and 304 does not require an actual separation step. It is sufficient for the bits of the corresponding sub-data words, for the subsequent calculation steps, to be separately picked off from their respective positions.

The second sub-data word 304 is then shifted towards the right in various copies by different step widths. That is diagrammatically symbolized in FIG. 2a) by the five copies 306 through 314 of the second sub-data word 304. Each copy is shifted towards the right by a step width which is predetermined for it, by virtue of the reduction polynomial used. The number of actually shifted summand terms 308 through 314 corresponds to the number of non-vanishing terms of a previously known reduction polynomial R(x), that do not form the term x^{m}. The copy 306 in contrast does not have to be shifted. The step width of a respective right-shift is equal to the difference of m and the order of a respective non-vanishing term of the reduction polynomial.

The order of a term x⁷⁴, assumed as an example, of a reduction polynomial R(x) is 74. In the field GF(2²³³), a summand term is produced for that term from the second sub-data word 304, being shifted towards the right by 159 positions. The parameters s0 through s3 shown in FIG. 2 represent the respective step widths of a respective right-shift.

By subsequently adding the formed summand terms 306 through 314 to the first sub-data word 302 (C0), that affords an intermediate result C′(x)=C′0(x)+C′1(x), which is illustrated as the block 320 and contains two corresponding sub-data words 322 and 324. A hatched region 324.1 only contains zeros by virtue of the method steps performed hitherto.

As however the sum data word 320 formed in that way is not yet completely reduced, the steps of picking off the second sub-data word 324 and right-shifting of the second sub-data word 324, in accordance with the parameters s0 through s3 of the irreducible polynomial R, as described hereinbefore, are executed once again. Corresponding right-shifted copies 326 through 334 of the second sub-data word 324 are shown in FIG. 2a).

It will be appreciated that, in place of the parallel shifting of copies, it is also possible to implement serial shift steps on one and the same sub-data word. However, parallel production of the right-shifted copies with various, parallel-connected right-shifters is faster.

As the term with the second highest occupied order in the reduction polynomial is less than half the maximum degree m, only two successive iteration steps are required for complete reduction. The sum data word 336 produced after renewed addition of the summand terms 326 through 334 to the first sub-data word 322 is therefore only of the maximum length m. It forms the desired reduced second data word.

FIG. 2b) shows a method corresponding to the method of FIG. 2a), for the situation where the maximum field length of the incoming data words is less than the permissible data word width n of the reducer according to the invention.

In addition to the method steps shown in FIG. 1, initially a first adjustment step is carried out, which provides that the length of the first data word modified in that way is equal to the length 2n−1 supported in hardware terms, and that, in the first data word 350 modified in that way, those terms of the polynomial C(x) corresponding to the first data word, that are of an order of greater than m, are arranged at the same bit positions as if the first data word 350 had already initially involved the length 2n−1. Accordingly the left-shift carried out in that way in the first adjustment step corresponds to a shift by (n−m), wherein n signifies the greatest length of a data word, supported in hardware terms. Accordingly the supported word width at the input of the reducer is 2n−1.

The step width of that left-shift in the first adjustment step is referred to as the filling step width because the bit positions occurring in that fashion, in the fields 352.1 and 354.1 at the edge of the sub-data words 352 and 354, are filled with zeros.

The reduction method is then described as in FIG. 2a), with that first data word 350 modified in that fashion. In that respect summand terms 356 through 364 are formed in a first iteration step and added to the first sub-data word 352. The sum data word 370 obtained in that way contains in its overhanging second sub-data word 374 a block 374.1 which consists entirely of zeros. The remaining non-vanishing bit positions of the overhanging second sub-data word 374 are removed in a second iteration step by the formation of summand terms 376 through 384 and addition to the first sub-data word 372, resulting in a sub-data word 386. In a final second adjustment step that is shifted by the same number of bit positions, that is to say by the filling step width, towards the right, to remove the right-side block 386.1 which was initially produced by adding zeros. The remaining block 386.2 corresponds to the second data word which is being sought and which is equivalent to the first data word.

FIG. 3 shows an alternative method flow for the situation where m<n, which also formed the basis for the method implementation in FIG. 2b). The view in FIG. 3 is subdivided into four main method blocks S400, S410, S420 and S430.

The method block S400 includes a first adjustment step S402 in which an incoming data word 450, the length 2m−1 of which is less than the length 2n−1 supported in hardware terms, is shifted towards the left by a filling step width sf. The data word 450′ modified in that way includes a first sub-data word 452 and a second sub-data word 454. They are also identified in FIG. 4 as usual by C0 and C1. That identification also embraces the blocks 452.1 and 454.1 which are present at the left-hand and right-hand sides and which are filled with zeros.

The second data word 454 is then shifted towards the right in three right-shift steps carried out in parallel, by the step widths S1, S2 and S3, in corresponding steps S412, S414 and S416. The summand terms formed in that way are then added in an adding step S418 to the first sub-data word 452.

It is to be noted that, in the method in FIG. 2, the summand terms were added to C (300). In the method implementation in FIG. 2 they are only still added to C0 (452). Accordingly in the present embodiment (having recourse to the references used) the operation (304)+(306) which always results in zero is omitted. In the present method implementation therefore in total only four terms are added to the first sub-data word.

After the partial reduction effected in that way the sum data word 470 at the output of the adding step 418, in the next iteration step S420, is subjected to a corresponding sequence of steps S422 through S428, as was described in detail in relation to FIG. 2b).

In a subsequent second adjustment step S432 the sum data word 486 afforded at the output of the adding step S428 is shifted towards the right by the filling step width sf, whereby a correspondingly modified sum data word 488 is formed. The second sub-data words 457 and 474 are then added thereto in a further adding step S434, whereby the desired reduced second data word 490 is present at the output of the adding step 434.

The advantage of this method implementation is that a right-shift step is saved in each iteration step. That means that one right-shifter less is required in a corresponding hardware implementation, and that leads on the one hand to an additional acceleration in the method and on the other hand a saving in space.

FIG. 4 shows a block diagram of a reducer adapted to implement the method procedure corresponding to FIGS. 2a) and 2b). The reducer 500 is connected downstream of a multiplier M, at the output of which there are data words of the length 2m−1. Such a data word which forms the product of a multiplication operation carried out in the multiplier M is fed to a first adjustment unit 502 which performs a left-shift corresponding to the step S402 in FIG. 3. In this case the first adjustment unit 502 is actuated by a control unit 504 which predetermines the parameter m, that is to say the field size of the data words. The first adjustment unit determines a filling step width on the basis of that parameter, as described hereinbefore. After a left-shift, effected with the filling step width, of the first data word at the input, the adjustment unit fills with zeros at the left-hand and right-hand edges so that a data word of the word length 2n−1 supported by the reducer 500 is to be found at the output of the first adjustment unit 502. In the first data word modified in that way, those terms of the polynomial C(x) corresponding to the original first data word, that are an order greater than m, are at the same bit positions as if the original data word had already been of the length 2n−1.

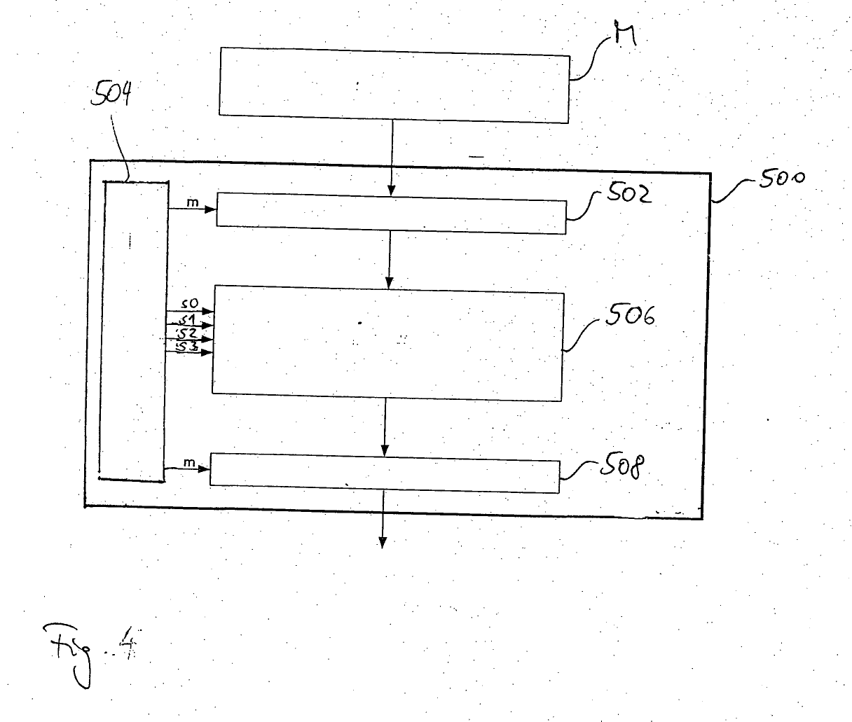

Connected downstream of the first adjustment unit 502 is a reducing unit 506, the operation of which is also controlled by the control unit 504. It supplies the reducing unit in particular with the parameters S0 through S3 required for the right-shifts described in detail with reference to FIGS. 2a) and 2b) and FIG. 3. The structure of the reducing unit is described in greater detail by reference to FIGS. 6 and 7 hereinafter in alternative embodiments.

A second adjustment unit 508 is connected downstream of the reducing unit 506. It provides for reverse transformation of the sum data word at the output of the reducer by a right-shift and removal of the zeros inserted at the start in the first adjustment unit. The desired reduced second data word is then present at the output of the second adjustment unit 508.

FIG. 5 shows an alternative implementation of the reducing unit in which operation is effected with only one right-shifter 702 which produces serially differently far-shifted copies of the second sub-data word which are added to the respective first sub-data word.

The reducing unit 706 in FIG. 5 accordingly requires many cycles for a reduction step, in which respect it is presupposed that the right-shifts are carried out in the order S3≦S2≦S1≦S0 so that the shift is successively towards the right.

1. A method of reducing a first data word corresponding to a polynomial C(x) and having a length of a maximum of 2n−1 to a second data word of a length of a maximum m which in a binary finite field GF(2^{m}) whose elements are of a maximum length m corresponds to a polynomial C″0(x) equivalent to C(x), wherein m is either smaller than or equal to n, comprising the steps:
providing a reduction polynomial R(x) which forms a trinomial or a pentanomial;
partitioning the first data word into a binary first sub-data word C0 and a binary second sub-data word C1 whose corresponding polynomials C0(x) and C1(x) satisfy the equation C(x)=C1(x)*x^{m}+C0(x), and picking off the second sub-data word to form a first summand term;
right-shifting the second sub-data word to form a second summand term and repeating the right-shifting step to form further summand terms until a respective summand term is associated with each non-vanishing term of the reduction polynomial which is not the term x^{m} by the step width of a respective right-shift being equal to the difference of m and the order of a respective non-vanishing term of the reduction polynomial;
adding the formed summand terms to the first sub-data word to form a sum data word;
if the sum data word ascertained in that way is of a length greater than m, application of the method steps from the partitioning step to the summand data word formed until the sum data word ascertained in that way is of a length of a maximum m and thus forms the second data word.

2. A method of reducing a first data word corresponding to a polynomial C(x) and having a length of a maximum of 2n−1 to a second data word of a length of a maximum m which in a binary finite field GF(2^{m}) whose elements are of a maximum length m corresponds to a polynomial C″0(x) equivalent to C(x), wherein m is either smaller than or equal to n, comprising the steps:
providing a reduction polynomial R(x) which forms a trinomial or a pentanomial;
partitioning the first data word into a binary first sub-data word C0 and a binary second sub-data word C1 whose corresponding polynomials C0(x) and C1(x) satisfy the equation C(x)=C1(x)*x^{m}+C0(x), and picking off the second sub-data word to form a first summand term;
right-shifting the second sub-data word to form a second summand term and repeating the right-shifting step to form further summand terms until a respective summand term is associated with each non-vanishing term of the reduction polynomial which is not the term x^{m} by the step width of a respective right-shift being equal to the difference of m and the order of a respective non-vanishing term of the reduction polynomial;
adding the formed summand terms with the exception of the first summand term, to the first data word;
if the sum data word ascertained in that way is of a length greater than m, application of the method steps from the partitioning step to the summand data word formed until the sum data word ascertained in that way is of a length of a maximum m; and
adding the first summand term and in the stated case of an application of the method steps from the partitioning step to the formed summand data word each further second sub-data word which has been ascertained in the meantime to the last-ascertained sum data word to form the second data word.

3. A method as set forth in claim 1 wherein the first data word is of a length of less than 2n−1, comprising an additional first adjustment step which is performed prior to the right-shift operation and which includes a left-shift of the first data word by a filling step width and attachment at both sides of a number of zeros corresponding to the filling step width to the first data word in such a way that the length of the first data word modified in that way is 2n−1 and that in the modified first data word those terms of the polynomial C(x) corresponding to the first data word, that are of an order of greater than m, are arranged at the same bit positions as if the first data word were already initially of the length 2n−1.

4. A method as set forth in claim 3 comprising a second adjustment step which includes removal of the initially attached zeros from the ascertained sum data word and a right-shift of the sum data word by the filling step width.

5. A method as set forth in claim 1 wherein the irreducible polynomial is represented solely by the powers of the non-vanishing terms of the reduction polynomial, which are not the term x^{m}.

6. A method as set forth in claim 5 wherein the irreducible polynomial is additionally represented by the known maximum length m of data words of the binary finite field.

7. An asymmetric cryptography method for use in an electronic cryptography apparatus comprising
reducing a first data word corresponding to a polynomial C(x) and of a length of a maximum of 2n−1 to a second data word of a length of a maximum m which in a binary finite field GF(2^{m}) whose elements are of a maximum length m corresponds to a polynomial C″0(x) equivalent to C(x), wherein m is either less than or equal to n, in accordance with a method as set forth in claim 1.

8. An asymmetric cryptography method as set forth in claim 7 which forms a method of elliptic curve cryptography, including prior to the reduction operation:
multiplying two factor data words corresponding to factor polynomials A(x) and B(x) to give the first data word corresponding to a polynomial C(x) of a length of a maximum of 2n−1.

9. A method of calculating a digital signature including an asymmetric cryptography method as set forth in claim 8.

10. Apparatus for the reduction of a first data word corresponding to a polynomial C(x) and of a length of a maximum of 2n−1 to a second data word of a length of a maximum m which in a binary finite field GF(2^{m}) whose elements are of a maximum length m corresponds to a polynomial C″0(x) equivalent to C(x), wherein m is either less than or equal to n, comprising:
a memory which contains a representation of at least one reduction polynomial R(x) which forms a trinomial or pentanomial;
a selection unit which is adapted to pick off a binary sub-data word from the first data word, whose corresponding polynomial C1(x) complies with the equation C(x)=C1(x)*x^{m}+C0(x) and which forms a first summand term;
a shift unit connected to the selection unit and adapted to shift the sub-data word towards the right by a respectively predetermined step width for forming a second or further summand terms and to output the formed summand terms;
an adding unit connected to the shift unit and adapted to add a respective summand term and the summands outputted by the shift unit to the first data word; and
a control unit which is adapted
to determine the step width of a respective right-shift to be performed by the shift unit for forming a summand term as a difference of m and the order of a respective non-vanishing term of the reduction polynomial,
to instruct the shift unit for repeated execution of the right-shift step for a formation of further summand terms with respective freshly determined step width until a respective summand term is associated with each non-vanishing term of a respectively predetermined reduction polynomial which is not the term x^{m}, and
to again activate if necessary the calculation unit, the shift unit and the adding unit until an ascertained sum data word is of a length of a maximum m and thus forms the second data word.

11. Apparatus as set forth in claim 10 wherein the control unit is adapted to instruct the adding unit in the case of a repetition of the method steps from the step of ascertaining a binary sub-data word to add the respectively formed summand terms with the exception of the first summand term to the respective first data word,
and after establishing that an ascertained sum data word is of a length which is no greater than m, for forming the second data word, to add each first summand term ascertained in the meantime to the ascertained sum data word.

12. Apparatus as set forth in claim 10 comprising a first and a second adjustment unit,
wherein the first adjustment unit is adapted to shift an incoming first data word of a length of less than 2n−1, prior to the right-shift operation, by a filling step width towards the left and on both sides of the first data word to attach a number of zeros corresponding to the filling step width to the first data word in such a way that the length of the first data word modified in that way is 2n−1 and that in the modified first data word those terms of the polynomial C(x) corresponding to the first data word, that are of an order of greater than m, are arranged at the same bit positions as if the first data word were already initially of the length 2n−1, and
wherein the second adjustment unit is adapted to shift the ascertained sum data word of the length of a maximum m by the filling step width towards the right and to remove the initially added zeros.

13. Apparatus as set forth in claim 10 wherein the shift unit includes a number of parallel-connected right-shifters, to which the sub-data word is fed.

14. Apparatus as set forth in claim 10 wherein the shift unit includes precisely one right-shifter and wherein the control unit is adapted to effect the repetition of the right-shift step for forming further summand terms by additional right-shifting of the summand term last outputted by the right-shifter by a respective difference step width, wherein the respective difference step width is the difference between the right-shifts of successive summand terms in each case in relation to the first summand term.

15. An electronic cryptography apparatus including a reduction apparatus as set forth in claim 10.

16. An electronic cryptography apparatus as set forth in claim 15 adapted for encryption or decryption of data in accordance with a method of elliptic curve cryptography.

17. An electronic cryptography apparatus as set forth in claim 16 comprising a multiplier apparatus adapted to multiply two factor data words corresponding to factor polynomials A(x) and B(x) to give a first data word corresponding to the polynomial C(x) of a length of a maximum of 2n−1.

18. A method as set forth in claim 2 wherein the first data word is of a length of less than 2n−1, comprising an additional first adjustment step which is performed prior to the right-shift operation and which includes a left-shift of the first data word by a filling step width and attachment at both sides of a number of zeros corresponding to the filling step width to the first data word in such a way that the length of the first data word modified in that way is 2n−1 and that in the modified first data word those terms of the polynomial C(x) corresponding to the first data word, that are of an order of greater than m, are arranged at the same bit positions as if the first data word were already initially of the length 2n−1.

19. A method as set forth in claim 2 wherein the irreducible polynomial is represented solely by the powers of the non-vanishing terms of the reduction polynomial, which are not the term x^{m}.

20. A method as set forth in claim 3 wherein the irreducible polynomial is represented solely by the powers of the non-vanishing terms of the reduction polynomial, which are not the term x^{m}.

21. A method as set forth in claim 4 wherein the irreducible polynomial is represented solely by the powers of the non-vanishing terms of the reduction polynomial, which are not the term x^{m}.

22. An asymmetric cryptography method for use in an electronic cryptography apparatus comprising
reducing a first data word corresponding to a polynomial C(x) and of a length of a maximum of 2n−1 to a second data word of a length of a maximum m which in a binary finite field GF(2^{m}) whose elements are of a maximum length m corresponds to a polynomial C″0(x) equivalent to C(x), wherein m is either less than or equal to n, in accordance with a method as set forth in claim 2.

23. An asymmetric cryptography method for use in an electronic cryptography apparatus comprising
reducing a first data word corresponding to a polynomial C(x) and of a length of a maximum of 2n−1 to a second data word of a length of a maximum m which in a binary finite field GF(2^{m}) whose elements are of a maximum length m corresponds to a polynomial C″0(x) equivalent to C(x), wherein m is either less than or equal to n, in accordance with a method as set forth in claim 3.

24. An asymmetric cryptography method for use in an electronic cryptography apparatus comprising
reducing a first data word corresponding to a polynomial C(x) and of a length of a maximum of 2n−1 to a second data word of a length of a maximum m which in a binary finite field GF(2^{m}) whose elements are of a maximum length m corresponds to a polynomial C″0(x) equivalent to C(x), wherein m is either less than or equal to n, in accordance with a method as set forth in claim 4.

25. An asymmetric cryptography method for use in an electronic cryptography apparatus comprising
reducing a first data word corresponding to a polynomial C(x) and of a length of a maximum of 2n−1 to a second data word of a length of a maximum m which in a binary finite field GF(2^{m}) whose elements are of a maximum length m corresponds to a polynomial C″0(x) equivalent to C(x), wherein m is either less than or equal to n, in accordance with a method as set forth in claim 5.

26. An asymmetric cryptography method for use in an electronic cryptography apparatus comprising
reducing a first data word corresponding to a polynomial C(x) and of a length of a maximum of 2n−1 to a second data word of a length of a maximum m which in a binary finite field GF(2^{m}) whose elements are of a maximum length m corresponds to a polynomial C″0(x) equivalent to C(x), wherein m is either less than or equal to n, in accordance with a method as set forth in claim 6.

27. Apparatus as set forth in claim 11 comprising a first and a second adjustment unit,
wherein the first adjustment unit is adapted to shift an incoming first data word of a length of less than 2n−1, prior to the right-shift operation, by a filling step width towards the left and on both sides of the first data word to attach a number of zeros corresponding to the filling step width to the first data word in such a way that the length of the first data word modified in that way is 2n−1 and that in the modified first data word those terms of the polynomial C(x) corresponding to the first data word, that are of an order of greater than m, are arranged at the same bit positions as if the first data word were already initially of the length 2n−1, and
wherein the second adjustment unit is adapted to shift the ascertained sum data word of the length of a maximum m by the filling step width towards the right and to remove the initially added zeros.

28. Apparatus as set forth in claim 11 wherein the shift unit includes a number of parallel-connected right-shifters, to which the sub-data word is fed.

29. Apparatus as set forth in claim 12 wherein the shift unit includes a number of parallel-connected right-shifters, to which the sub-data word is fed.

30. Apparatus as set forth in claim 11 wherein the shift unit includes precisely one right-shifter and wherein the control unit is adapted to effect the repetition of the right-shift step for forming further summand terms by additional right-shifting of the summand term last outputted by the right-shifter by a respective difference step width, wherein the respective difference step width is the difference between the right-shifts of successive summand terms in each case in relation to the first summand term.

31. Apparatus as set forth in claim 12 wherein the shift unit includes precisely one right-shifter and wherein the control unit is adapted to effect the repetition of the right-shift step for forming further summand terms by additional right-shifting of the summand term last outputted by the right-shifter by a respective difference step width, wherein the respective difference step width is the difference between the right-shifts of successive summand terms in each case in relation to the first summand term.

32. An electronic cryptography apparatus including a reduction apparatus as set forth in claim 11.

33. An electronic cryptography apparatus including a reduction apparatus as set forth in claim 12.

34. An electronic cryptography apparatus including a reduction apparatus as set forth in claim 13.

35. An electronic cryptography apparatus including a reduction apparatus as set forth in claim 14.
